(19) United States
(12) Patent Application Publication
(10) Pub. No.: US 2026/0258607 A1
(43) Pub. Date: Sep. 3, 2026

(54) WATER BASED BARRIER COATING COMPRISING n-OSA MODIFIED STARCH

(71) Applicant: CARGILL, INCORPORATED, Wayzata, MN (US)

(72) Inventors: Massimo Bregola, Rome (IT); Richard Thalhofer, Ratingen (DE)

(73) Assignee: CARGILL, INCORPORATED, Wayzata, MN (US)

(21) Appl. No.: 18/881,842

(22) PCT Filed: Jul. 10, 2023
(86) PCT No.: PCT/US2023/069890

§ 371 Date: Jan. 7, 2025

Related U.S. Application Data
(60) Provisional application No. 63/368,172, filed on Jul. 12, 2022.

(51) Int. Cl. D21H 19/54; C08K 3/34; C09D 7/40; C09D 7/61; C09D 103/16; D21H 19/40; D21H 27/10

(52) U.S. Cl. CPC D21H 19/54; C09D 103/16; D21H 19/40; D21H 27/10; C08K 3/346; C09D 7/61; C09D 7/69

(57) ABSTRACT

Aqueous coating compositions for providing a grease resistant coating on fiber-based substrates are provided that comprise an n-OSA modified starch having an Mw of from about 500,000 to about 1,300,000 and a degree of substitution of from 0.002 to about 0.009, the n-OSA modified starch being present as from about 5 wt % to about 40 wt % of the total aqueous coating composition. The aqueous coating composition has a Brookfield viscosity at 30° C. at 100 rpm of from about 50 to about 2500 mPas; and the n-OSA modified starch is at least about 92% of any starch present in the aqueous coating composition.

Methods of preparing the coating composition, fiber-based products comprising a coating of the coating composition, and methods of preparing these coated fiber-based product are also described.

### CROSS-REFERENCE TO RELATED APPLICATIONS

This application claims the benefit of U.S. Provisional Application No. 63/368,172, filed Jul. 12, 2022, which is incorporated by reference herein in its entirety.

### FIELD

The present invention relates to water-based barrier coatings. In an aspect, the present invention relates to water-based barrier coatings for fiber-based materials.

### BACKGROUND

Food containers and wrapping materials have been provided with grease and water resistant coatings for many years. U.S. Pat. No. 3,316,123 to Savina describes paper coated with a flexible grease and water-resistant ethyl acrylate acrylonitrile copolymer having a molecular weight in excess of about 1,000,000. This coated paper is stated to possess substantially no tendency towards blocking, even when maintained at temperatures as high as 190° F. for protracted periods of time, when the coating has a uniform substantial content of a thermoset amine-formaldehyde condensate.

A paper coating composition comprising one or more thickeners is described in US Published Pat. Appln No. 2007/0113997 to Glittenberg for use in the preparation of smoother, higher gloss paper products with improved optical properties such as opacity and whiteness and improved printing properties such as printing gloss. At least one of the one or more thickeners is a cold water swellable starch ester, methods of preparing such compositions and their use in coating paper products. US Published Pat. Appln No. 2013/004015 to Marakainen likewise describes a coating for coated papers used for printing. The coating compositions contain a starch mixture comprising a non-thinned starch and a thinned starch.

U.S. Pat. No. 7,955,428 to Aoki describes a processed biodegradable article having excellent water resistance and rigidity, which can be used as a food container. The biodegradable composition used to produce the processed biodegradable article comprises 15-75% by mass starch, 5-50% by mass protein, 3-50% by mass cellulose fiber, 0.5-20% by mass polyphenols such as pyrogallol and gallic acid, and 0-5% by mass sodium chloride. Various starches that may be used are described on column 3.

Various acrylic emulsions are known for use as barrier coatings for grease, such as RHOBARR™ 110 Binder from Dow and RHOBARR™ 130 Binder from Dow. The Technical Data Sheets for both of these binders indicate that they have “good stability when blended with inorganic pigments such as clay, calcium carbonate, titanium dioxide and talc,” and “good stability when blended with water soluble polymers such as starch, PVOH or rheology modifiers.”

U.S. Pat. No. 7,425,246 to Urscheler describes a method of manufacturing multilayer coated papers and paperboards, but excluding photographic papers and pressure sensitive copying papers, that are especially suitable for printing, packaging and labeling purposes, in which at least two curtain layers selected from aqueous emulsions or suspensions are formed into a composite, free-falling curtain and a continuous web of basepaper or baseboard is coated with the composite curtain, and paper or paperboard thereby obtainable.

Starches that have been modified with n-octenyl succinic anhydride (i.e., “n-OSA modified starch”) have been known as food additives for many years. For example, the use of n-OSA modified starch as an additive in dairy products is described in US Published Patent Application No. 2010/0278994A1 to Klemanszewski.

EP2762636A1 to Trksak describes surface sizing of paper with an agent containing bound octenyl succinic anhydride groups made via the reaction of octenyl succinic anhydride onto a dispersed waxy starch.

WO2005047385A1 to Anderson describes processes for using modified starch compositions in preparing cellulosic webs, particularly paper, and the resultant cellulosic webs. There are also disclosed coatings comprising the modified starch compositions (including an n-OSA treated waxy starch) and the use thereof in coating substrates such as paper.

US 2003/0173045 to Confalone describes a liquid starch dispersion useful in paper and paperboard coating processes. The dispersion as shown in the examples and starting at claim 8 is a blend of a cationic starch with an n-OSA starch.

U.S. Pat. No. 4,872,951 to Maliczyszyn describes a series of blends of ASA-treated and cationic starches for use as external sizes of paper and paperboard products. The blends contain at least 30% (by wt) of the ASA-treated starch, which is a monoester of the starch and an alkyl or alkenyl succinate and, optionally, from about 0.5 to about 5% (by weight based on the starch) of an Al3+ salt.

U.S. Pat. No. 4,239,592 to Gaspar describes the use of aqueous dispersions of blends of hydrophobic starch monoesters of specified dicarboxylic acids and non-hydrophobic starches as surface sizes in accordance with the process of this invention results in the preparation of paper and paperboard products which display significantly improved size properties. See column 2, lines 3-9. The hydrophobic starch monoesters may be prepared by reacting starch with the cyclic anhydride of the selected dicarboxylic acid. Among the suitable acid anhydrides are included 1,4,5,6,7,7-hexachloro-5-norbornene-2,3-dicarboxylic anhydride, phthalic anhydride, tetrachlorophthalic anhydride, 1-octenylsuccinic anhydride, endo-cis-5-norbornene-2,3-dicarboxylic anhydride, 1,2-cyclohexane-dicarboxylic anhydride, cis-4-cyclohexene-1,2-dicarboxylic anhydride, etc. See column 3, lines 20-28.

U.S. Pat. No. 2,661,349 to Caldwell describes derivatives of starch, having greatly improved qualities as emulsifying agents, thickeners, sizes, and other commercial applications.

### SUMMARY

Food packaging material advantageously is resistant to oil, grease and water. However, providing fiber-based food packaging materials, such as paper and cardboard, with such resistance may be challenging. The technologies currently employed include coating the fiber-based materials with fluorochemicals or laminating the fiber-based materials plastic laminate materials. Both of these approaches are falling out of favor. Many jurisdictions are banning certain fluorochemicals. Likewise, there is a strong movement to ban plastics, and particularly microplastics, because these materials are disfavored for environmental concerns and are difficult to recycle in the food packaging context for a number of reasons.

Alternative barrier coating materials, such as acrylate based latex coatings, face particular obstacles such as difficulties in coating due to the rheology, and challenges in sustainability because repulpability during recycling of post-consumer product is a problem when the coating generates tacky particles (so called “stickies”). Finally, coatings having a high acrylate content are expensive.

It has been discovered that aqueous coating compositions that are effective barrier coatings for fiber-based substrates may be prepared comprising an n-OSA modified starch having an Mw of from about 500,000 to about 1,300,000 and a degree of substitution of from 0.002 to about 0.009, the n-OSA modified starch being present as from about 5 wt % to about 40 wt % of the total aqueous coating composition. The aqueous coating composition has a Brookfield viscosity at 30° C. at 100 rpm of from about 50 to about 2500 mPas and the n-OSA modified starch is at least about 92% of any starch present in the aqueous coating composition.

It has been found that by selecting the molecular weight and degree of substitution characteristics, the n-OSA starch may be used with little or no other starch additives, and in an aspect with little or no other polymeric additives to provide a highly effective barrier coating, and in an aspect a highly effective grease resistant coating. Moreover, it has advantageously been found that by having a high percentage of the starch present in the in the aqueous coating composition being n-OSA modified starch is beneficial in providing excellent coated product performance properties, even though the degree of substitution of the starch with n-OSA is quite low. Thus, while n-OSA starch could have a very high degree of substitution, when used as an ingredient in food the permitted degree of substitution is limited to a maximum of only 0.03 (i.e., 3% of the available hydroxyl groups on the starch having been substituted with ester functionalities). The degree of substitution of the n-OSA modified starch that is effective for use in the present barrier coating is much less than the degree of substitution of the starch when used as an ingredient in food—i.e., a degree of substitution of only from 0.002 to about 0.009.

The ingredients used in the present coating compositions are relatively low cost, and provide excellent product performance in high grease resistance, and high flexibility in the resulting coated fiber-based products.

Moreover, the resulting coated fiber-based products provide excellent sustainability, because the coatings may be prepared predominantly or exclusively from materials defined as bio-sourced materials. Additionally, the resulting coated fiber-based products may be prepared as readily recyclable materials, because the present coating composition may be formulated to substantially avoid generation of “stickies” that are problematic or prohibitive in obtaining successful post-consumer recycling outcomes.

In an aspect, the coated fiber-based product as described herein is prepared by providing a fiber-based substrate having a first and second major surface, and coating the first major surface with the aqueous coating composition of claim 1 at a coating weight of from about 2 g/m² to about 15 g/m².

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The accompanying drawings, which are incorporated in and constitute a part of this application, illustrate several aspects of the invention and together with a description of the embodiments serve to explain the principles of the invention. In the drawings, like reference numbers represent like parts. A brief description of the drawings is as follows.

FIG. 1 is a graph presenting experimental results of coating compositions.

### DETAILED DESCRIPTION

The aspects of the present invention described below are not intended to be exhaustive or to limit the invention to the precise forms disclosed in the following detailed description. Rather a purpose of the aspects chosen and described is by way of illustration or example, so that the appreciation and understanding by others skilled in the art of the general principles and practices of the present invention can be facilitated.

As noted above, in an aspect, the aqueous coating composition comprises an n-OSA modified starch having an Mw of from about 500,000 to about 1,300,000 and a degree of substitution of from 0.002 to about 0.009, the n-OSA modified starch being present as from about 5 wt % to about 40 wt % of the total aqueous coating composition, and the n-OSA modified starch is at least about 92% of any starch present in the aqueous coating composition.

The n-OSA starch used in the present compositions is starch that has been chemically modified in a starch esterification process by reacting hydroxyl groups on the starch with, for example, n-octenyl succinic anhydride to form the n-OSA starch. The degree of substitution of the available hydroxyl groups with ester functionalities has been found to affect the physiochemical properties of the starch. It has been found that in starches wherein less than all of the hydroxyl groups have been substituted, the resulting starches will exhibit unique amphiphilic and interfacial properties. While not being bound by theory, it is believed that n-OSA starches having particular degree of substitution values provide unique solubility characteristics in various solutions, and will exhibit unique interaction behaviors with components in coating compositions or with the materials of the substrate to be coated.

In an aspect, the n-OSA starch has a degree of substitution of from about 0.002 to about 0.009 (i.e., wherein from about 0.2% to about 0.9% of the available hydroxyl groups on the starch having been substituted with ester functionalities). In an aspect, the n-OSA starch has a degree of substitution of from about 0.002 to about 0.008. In an aspect, the n-OSA starch has a degree of substitution of from about 0.002 to about 0.007. In an aspect, the n-OSA starch has a degree of substitution of from about 0.002 to about 0.006. In an aspect, the n-OSA starch has a degree of substitution of from about 0.003 to about 0.008. In an aspect, the n-OSA starch has a degree of substitution of from about 0.003 to about 0.007. In an aspect, the n-OSA starch has a degree of substitution of from about 0.003 to about 0.006. In an aspect, the n-OSA starch has a degree of substitution of from about 0.004 to about 0.008. In an aspect, the n-OSA starch has a degree of substitution of from about 0.004 to about 0.007. In an aspect, the n-OSA starch has a degree of substitution of from about 0.004 to about 0.006.

For purposes of the present discussion, degree of substitution of the n-OSA starch is determined by extracting free octenylsuccinic acid from the modified starch with isopropanol containing an internal standard, and then extracting total octenylsuccinic acid with isopropanol after alkali hydrolysis and acidification of the modified starch. The amount of octenylsuccinic acid in the isopropanol extracts is quantified by HPLC using external standards. Bound octenylsuccinic acid is calculated as the difference between total and free octenylsuccinic acid.

In an aspect, the n-OSA starch has an Mw of from about 1,200,000 to about 1,250,000. In an aspect, the n-OSA starch has an Mn of from about 25,000 to about 35,000; or wherein the n-OSA modified starch has an Mn of from about 28,000 to about 33,000. In an aspect, the n-OSA starch has a polydispersity of from about 35 to about 50. In an aspect, the n-OSA starch has a polydispersity of from about 40 to about 45.

In an aspect, the n-OSA starch is prepared by functionalizing a starch selected from maize starch, potato starch, sweet potato starch, wheat starch, rice starch, tapioca starch, sorghum starch, waxy maize starch, waxy potato starch, waxy sweet potato starch, waxy wheat starch, waxy rice starch, waxy tapioca starch, and waxy sorghum starch. In an aspect, the n-OSA starch is prepared by functionalizing a maize starch.

In an aspect, the content of amylose and the content of amylopectin contained in the starch source are not particularly limited. In an aspect, the starch source has increased content of amylose, such as high-amylose maize starch. Preferably, the n-OSA modified starch is a starch prepared from a starch having an amylopectin content of from about 85 to 100% by weight. In an aspect, the n-OSA modified starch is a starch prepared from a starch having an amylopectin content of from about 88 to 100% by weight. In an aspect, the n-OSA modified starch is a starch prepared from a starch having an amylopectin content of from about 90 to 100% by weight. In an aspect, the n-OSA modified starch is a starch prepared from a starch having an amylopectin content of from about 95 to 100% by weight. In an aspect, the n-OSA modified starch is a starch prepared from a starch having an amylopectin content of from about 98 to 100% by weight.

In an aspect, the n-OSA starch present in the aqueous coating composition has been prepared from only one type of starch source. In an aspect, the aqueous coating composition comprises mixtures of n-OSA starches that have been prepared from two or more types of starch sources.

In an aspect, the starch source used to prepare the n-OSA starch has been acid thinned prior to esterification to form the n-OSA starch. In an aspect, the n-OSA starch has been acid thinned after esterification to form the n-OSA starch.

In an aspect, the starch source used to prepare the n-OSA starch has been enzyme treated to reduce the molecular weight of the starch (thereby reducing viscosity of the ultimate composition) prior to esterification to form the n-OSA starch. In an aspect, the n-OSA starch has been enzyme treated to reduce the molecular weight of the starch after esterification to form the n-OSA starch.

In an aspect, the n-OSA modified starch is present as from about 8% to about 40% based on the total aqueous coating composition. In an aspect, the n-OSA modified starch is present as from about 5% to about 25% based on the total aqueous coating composition. In an aspect, the n-OSA modified starch is present as from about 8% to about 25% based on the total aqueous coating composition. In an aspect, the n-OSA modified starch is present as from about 10% to about 25% based on the total aqueous coating composition. In an aspect, the n-OSA modified starch is present as from about 10% to about 20% based on the total aqueous coating composition.

In an aspect, the aqueous coating composition comprises a non n-OSA modified starch in an amount less than 5% of the aqueous coating composition. In an aspect, the n-OSA modified starch is present as at least about 95% of any starch present in the aqueous coating composition. In an aspect, the n-OSA modified starch is present as at least about 97% of any starch present in the aqueous coating composition. In an aspect, the n-OSA modified starch is present as at least about 98% of any starch present in the aqueous coating composition. In an aspect, the n-OSA modified starch is present as at least about 99% of any starch present in the aqueous coating composition.

In an aspect, the aqueous coating composition comprises a filler. In an aspect, the aqueous coating composition comprises a filler selected from the group consisting of talc, bentonite, calcium carbonate, clay, and mixtures thereof. For purposes of the present discussion, talc is a mineral material comprising hydrated magnesium silicate. In an aspect, the talc is a platy talc that has undergone a beneficiation process to ensure consistent properties.

In an aspect, the aqueous coating composition comprises a filler in an amount of from about 1 wt % to about 50 wt % based on dry solids content of the composition. In an aspect, the filler is present in an amount of from about 5 wt % to about 40 wt % based on dry solids content of the composition. In an aspect, the filler is present in an amount of from about 5 wt % to about 35 wt % based on dry solids content of the composition. In an aspect, the aqueous coating composition comprises a filler in an amount of from about 5 wt % to about 50 wt % based on dry solids content of the composition. In an aspect, the aqueous coating composition comprises a filler in an amount of from about 10 wt % to about 50 wt % based on dry solids content of the composition. In an aspect, the aqueous coating composition comprises a filler in an amount of from about 15 wt % to about 50 wt % based on dry solids content of the composition. In an aspect, the aqueous coating composition comprises a filler in an amount of from about 20 wt % to about 50 wt % based on dry solids content of the composition.

In an aspect, the talc has an average particle size of from about 1 to 25 μm. In an aspect, the talc has an average particle size of from about 5 to 20 μm. In an aspect, the talc has an average particle size of from about 8 to 18 μm. In an aspect, the talc has an average particle size of from about 10 to 15 μm.

In an aspect, the talc is provided with a dispersing agent to assist in formulation of the aqueous coating compositions. Talcs are commercially available in various grades. Examples of suitable talcs include Finntalc™ C10 and C15 products, such as Finntalc™ C10B2 and Finntalc™ C15B2 from Elementis, London, UK.

In an aspect, the aqueous coating composition comprises pigment in an amount of from about 1 wt % to about 20 wt % of the coating composition. In an aspect, the aqueous coating composition comprises pigment in an amount of from about 1 wt % to about 15 wt % of the coating composition. In an aspect, the aqueous coating composition comprises pigment in an amount of from about 1 wt % to about 10 wt % of the coating composition. In an aspect, the aqueous coating composition comprises pigment in an amount of from about 1 wt % to about 5 wt % of the coating composition.

In an aspect, the aqueous coating composition comprises plasticizer in an amount of from about 1 wt % to about 20 wt % of the coating composition. In an aspect, the aqueous coating composition comprises plasticizer in an amount of from about 1 wt % to about 15 wt % of the coating composition. In an aspect, the aqueous coating composition comprises plasticizer in an amount of from about 1 wt % to about 10 wt % of the coating composition. In an aspect, the aqueous coating composition comprises plasticizer in an amount of from about 1 wt % to about 5 wt % of the coating composition.

In an aspect, the aqueous coating composition has a total dry solids content of from about 15 to about 50 wt %. In an aspect, the aqueous coating composition has a total dry solids content of from about 20 to about 50 wt %.

In an aspect, the aqueous coating composition has a pH of from about 5 to 12. In an aspect, the aqueous coating composition has a pH of from about 7 to 12. In an aspect, the aqueous coating composition has a pH of from about 8 to 11. In an aspect, the aqueous coating composition has a pH of from about 9 to 10. In an aspect, the aqueous coating composition has a pH of about 9.2.

As noted above, in an aspect, the aqueous coating composition has a Brookfield Viscosity at 30° C. at 100 rpm of from about 50 to about 2500 mPas.

In an aspect, the aqueous coating composition is formulated to have a Brookfield Viscosity suitable for use with a size press. In an aspect, the aqueous coating composition comprises an n-OSA modified starch having an Mw of from about 500,000 to about 800,000 and the composition has a Brookfield viscosity at 30° C. at 50 rpm of from about 100 to about 500 mPas. In an aspect, the aqueous coating composition comprises an n-OSA modified starch having an Mw of from about 500,000 to about 800,000 and the composition has a Brookfield viscosity at 30° C. at 50 rpm of from about 50 to about 250 mPas.

In an aspect, the aqueous coating composition is formulated to have a Brookfield Viscosity suitable for use with a film press. In an aspect, the aqueous coating composition comprises an n-OSA modified starch having an Mw of from about 500,000 to about 1,000,000 and the composition has a Brookfield viscosity at 30° C. at 100 rpm of from about 400 to about 2500 mPas. In an aspect, the aqueous coating composition comprises an n-OSA modified starch having an Mw of from about 500,000 to about 1,000,000 and the composition has a Brookfield viscosity at 30° C. at 100 rpm of from about 400 to about 1800 mPas. In an aspect, the aqueous coating composition comprises an n-OSA modified starch having an Mw of from about 500,000 to about 1,000,000 and the composition has a Brookfield viscosity at 30° C. at 100 rpm of from about 500 to about 1300 mPas.

In an aspect, the aqueous coating composition is formulated to have a Brookfield Viscosity suitable for use with a coating press. In an aspect, the aqueous coating composition comprises an n-OSA modified starch having an Mw of from about 500,000 to about 1,300,000 and the composition has a Brookfield viscosity at 30° C. at 100 rpm of from about 500 to about 2500 mPas. In an aspect, the aqueous coating composition comprises an n-OSA modified starch having an Mw of from about 500,000 to about 1,300,000 and the composition has a Brookfield viscosity at 30° C. at 100 rpm of from about 800 to about 2500 mPas. In an aspect, the aqueous coating composition comprises an n-OSA modified starch having an Mw of from about 500,000 to about 1,300,000 and the composition has a Brookfield viscosity at 30° C. at 100 rpm of from about 1000 to about 2500 mPas. In an aspect, the aqueous coating composition comprises an n-OSA modified starch having an Mw of from about 500,000 to about 1,300,000 and the composition has a Brookfield viscosity at 30° C. at 100 rpm of from about 1200 to about 2500 mPas. In an aspect, the aqueous coating composition comprises an n-OSA modified starch having an Mw of from about 500,000 to about 1,300,000 and the composition has a Brookfield viscosity at 30° C. at 100 rpm of from about 1200 to about 2200 mPas.

In an aspect, the aqueous coating composition comprises an n-OSA modified starch having an Mw of from about 700,000 to about 1,300,000 and the composition has a Brookfield viscosity at 30° C. at 100 rpm of from about 500 to about 2500 mPas. In an aspect, the aqueous coating composition comprises an n-OSA modified starch having an Mw of from about 700,000 to about 1,300,000 and the composition has a Brookfield viscosity at 30° C. at 100 rpm of from about 800 to about 2500 mPas. In an aspect, the aqueous coating composition comprises an n-OSA modified starch having an Mw of from about 700,000 to about 1,300,000 and the composition has a Brookfield viscosity at 30° C. at 100 rpm of from about 1000 to about 2500 mPas. In an aspect, the aqueous coating composition comprises an n-OSA modified starch having an Mw of from about 700,000 to about 1,300,000 and the composition has a Brookfield viscosity at 30° C. at 100 rpm of from about 1200 to about 2500 mPas. In an aspect, the aqueous coating composition comprises an n-OSA modified starch having an Mw of from about 700,000 to about 1,300,000 and the composition has a Brookfield viscosity at 30° C. at 100 rpm of from about 1200 to about 2200 mPas.

In an aspect, the aqueous coating composition comprises an n-OSA modified starch having an Mw of from about 800,000 to about 1,300,000 and the composition has a Brookfield viscosity at 30° C. at 100 rpm of from about 500 to about 2500 mPas. In an aspect, the aqueous coating composition comprises an n-OSA modified starch having an Mw of from about 800,000 to about 1,300,000 and the composition has a Brookfield viscosity at 30° C. at 100 rpm of from about 800 to about 2500 mPas. In an aspect, the aqueous coating composition comprises an n-OSA modified starch having an Mw of from about 800,000 to about 1,300,000 and the composition has a Brookfield viscosity at 30° C. at 100 rpm of from about 1000 to about 2500 mPas. In an aspect, the aqueous coating composition comprises an n-OSA modified starch having an Mw of from about 800,000 to about 1,300,000 and the composition has a Brookfield viscosity at 30° C. at 100 rpm of from about 1200 to about 2500 mPas. In an aspect, the aqueous coating composition comprises an n-OSA modified starch having an Mw of from about 800,000 to about 1,300,000 and the composition has a Brookfield viscosity at 30° C. at 100 rpm of from about 1200 to about 2200 mPas.

In an aspect, substrates having the aqueous coating composition as described herein coated thereon exhibits low tackiness. Providing a food packaging material that is resistant to oil, grease and water and additionally exhibits low tackiness is particularly advantageous, because if the food packaging material has a tacky surface, the sheet of material may stick to adjacent sheet surfaces. This causes problems in manufacture because it may not be possible to unspool a roll of the sheet material without damage to the substrate or transfer of an image printed on the back side of the sheet. Additionally, adjacent sheets provided to the user as a stack may stick together (i.e., “block”) and may actually form a solid mass that is not possible to separate at all. In an aspect, it has been found that compositions comprising n-OSA modified starches as described herein exhibit less tackiness in comparison to like compositions comprising unmodified starches rather than n-OSA modified starches.

For purposes of the present disclosure, tackiness of a coated substrate is determined by measuring the force required to separate two coated sheets of paper, which force value is identified as the Anton Paar “Wet tack” value. The Anton Paar “Wet tack” value is measured by an Anton Paar Rheometer MCR 101 device comprising a single use plate measuring system (model D-PP15/AL/S07) with a measuring axis (D-CP/PP7). A first coated sample is affixed to the measuring head of the rheometer, and a second coated sample is affixed to the plate, so during the measurement a coated side of one sample contacts the uncoated side of the other sample. The measuring axis is suspended and moved to a lifting position of 15 mm. 2 μl H2O are pipetted onto the sample adhered to the plate and the measuring geometry is moved to press the samples together with a constant normal force of 1 N for a time of 10 seconds. The Normal Force required to separate the two samples is measured at a temperature of 25° C.

In an aspect, the coating composition comprises only materials that have been formally approved for food contact in the relevant jurisdiction of use.

In an aspect, the aqueous coating composition comprises less than 5 wt % of a non-starch film forming polymer based on dry solids content of the composition. In an aspect, the aqueous coating composition comprises less than 2 wt % of a non-starch film forming polymer based on dry solids content of the composition. In aspect, the aqueous coating composition is free of a non-starch film forming polymer.

In an aspect, the aqueous coating composition comprises less than 5 wt % of a film forming polymer that is not an n-OSA starch based on dry solids content of the composition. In an aspect, the aqueous coating composition comprises less than 2 wt % of a film forming polymer that is not an n-OSA starch based on dry solids content of the composition. In aspect, the aqueous coating composition is free of a film forming polymer that is not an n-OSA starch.

In an aspect, the aqueous coating composition comprises less than 5 wt % of a styrene acrylic latex based on dry solids content of the composition. In an aspect, the aqueous coating composition comprises less than 2 wt % of a styrene acrylic latex based on dry solids content of the composition. In aspect, the aqueous coating composition is free of a styrene acrylic latex.

As a particular advantage, the present compositions may be formulated to be substantially free of intentionally added Microplastics. For purposes of the present discussion, “Microplastics” are defined as a solid polymer-containing particles with dimensions between 100 nm and 5 mm, to which additives or other substances may have been added. This definition does not apply to: Polymers in nature that have not been chemically modified, Biodegradable polymers; or Polymers with water-solubility>2 g/L. At the present time, many jurisdictions, such as the EU, are proposing a restriction or ban of the use of Microplastics in certain products. Certain components that are conventionally used in paper coating applications, such as acrylic latex components, may be defined as Microplastics.

As a particular advantage, the present compositions may be formulated to be substantially free of intentionally added fluorine containing components, such as perfluorinated surfactants.

In an aspect, the aqueous coating composition for coating fiber-based products may be prepared by cooking the n-OSA starch in water for a time and temperature sufficient to gelatinize the starch. In an aspect, the n-OSA starch is batch cooked with stirring in water at a temperature of about 95 degrees C. for a time of about 0.5 hours to one hour. The gelatinized starch is mixed with water in an amount sufficient to provide an aqueous coating composition having n-OSA modified starch present as from about 5 wt % to about 40 wt % of the total aqueous coating composition.

A coated fiber-based product is prepared by coating a fiber-based substrate with the coating composition as described herein.

For purposes of the present disclosure, the terms “paper” and “paper product” refer to sheet materials of any thickness, including, for example, single sheet paper, paperboard, cardboard and corrugated board. In an aspect the fiber-based substrate is a thin coated paper. In an aspect the fiber-based substrate is a flexible packaging sheet. In an aspect the fiber-based substrate is a rigid packaging substrate.

In an aspect, the fiber-based substrate has a basis weight of from about 20 g/m² to about 45 g/m²; or wherein the fiber-based substrate has a basis weight of from about 30 g/m² to about 40 g/m².

In an aspect, the fiber-based substrate has a basis weight of from about 46 g/m² to about 75 g/m2; or wherein the fiber-based substrate has a basis weight of from about 48 g/m² to about 70 g/m².

In an aspect, the fiber-based substrate has a basis weight of from about 76 g/m² to about 100 g/m2; or wherein the fiber-based substrate has a basis weight of from about 80 g/m² to about 90 g/m².

In an aspect, the fiber-based substrate has a basis weight of from about 101 g/m² to about 400 g/m²; or wherein the fiber-based substrate has a basis weight of from about 150 g/m² to about 350 g/m²; or wherein the fiber-based substrate has a basis weight of from about 180 g/m² to about 300 g/m².

The amount of coating composition to be applied to any given substrate is in part dependent on the surface characteristics of the substrates. Substrate materials that are very rough require more coating composition to achieve desired grease resistance properties than smooth substrates. Likewise, substrate materials that are very porous require more coating composition to achieve desired grease resistance properties than non-porous substrates. In an aspect, the substrate is coated by applying the coating composition to the substrate in a single application. In an aspect, the substrate is coated by applying the coating composition to the substrate in a plurality of applications, i.e., as a plurality of layers. In an aspect, the substrate is coated by applying the coating composition to the substrate in two applications, i.e., as two layers. In an aspect, coating the substrates with two or more layers is beneficial for providing complete and continuous coating on the substrate.

In an aspect, the fiber-based substrate has a Bendtsen Roughness value of from 1 to 800 ml/min on one side prior to coating with the composition. In an aspect, the fiber-based substrate has a Bendtsen Roughness value of from 5 to 600 ml/min on one side prior to coating with the composition. In an aspect, the fiber-based substrate has a Bendtsen Roughness value of from 10 to 400 ml/min on one side prior to coating with the composition. In an aspect, the fiber-based substrate has a Bendtsen Roughness value of from 10 to 200 ml/min on one side prior to coating with the composition. Bendtsen roughness is measured using ISO 8791/2. For purposes of the present discussion, a substrate having a Bendtsen Roughness value of from about 100 to about 800 ml/min prior to coating is considered to be a rough substrate.

In an aspect, the fiber-based substrate has a Bendtsen Porosity value of from about 0.3 to 700 ml/min prior to coating with the composition. In an aspect, the fiber-based substrate has a Bendtsen Porosity value of from about 0.3 to 500 ml/min prior to coating with the composition. In an aspect, the fiber-based substrate has a Bendtsen Porosity value of from about 0.3 to 300 ml/min prior to coating with the composition. In an aspect, the fiber-based substrate has a Bendtsen Porosity value of from about 0.3 to 100 ml/min prior to coating with the composition. In an aspect, the fiber-based substrate has a Bendtsen Porosity value of from about 0.3 to 10 ml/min prior to coating with the composition. Bendtsen porosity is measured using ISO 5636-3. For purposes of the present discussion, a substrate having a Bendtsen Porosity value of from about 0.3 to about 10 ml/min prior to coating is considered to be a low porous substrate.

In an aspect, a coated fiber-based product is prepared by coating a fiber-based substrate with the coating composition as described herein in an amount effective to provide a coated fiber-based product that exhibits a Grease Resistance Kit Rating of from 5 to 12, and a Coating Flexibility such that the Fold Grease Resistance Kit Rating does not drop below 5.

For purposes of the present disclosure, grease resistance of a coated substrate is measured under a Grease Resistance Test to determine the observed Grease Resistance Kit Rating in accordance with test methodology of TAPPI T559 Kit Test using a 3M Grease Resistance Kit—commonly known as the Kit test. In an aspect, the coated fiber-based product exhibits a Grease Resistance Kit Rating of from 5 to 12. In an aspect, the coated fiber-based product exhibits a Grease Resistance Kit Rating of from 6 to 12. In an aspect, the coated fiber-based product exhibits a Grease Resistance Kit Rating of from 7 to 12. In an aspect, the coated fiber-based product exhibits a Grease Resistance Kit Rating of from 8 to 12. In an aspect, the coated fiber-based product exhibits a Grease Resistance Kit Rating of from 9 to 12. In an aspect, the coated fiber-based product exhibits a Grease Resistance Kit Rating of from 10 to 12.

For purposes of the present disclosure, flexibility characteristics of a given coating composition is evaluated by coating the given coating composition on a substrate. This sample is evaluated under the Grease Resistance Test as described above, but in two measurements. In the first measurement, the Grease Resistance Test is carried out as described above on a coated surface of the sample that has never been folded to determine that the Initial Grease Resistance Kit Rating meets the desired performance standard for the coating. In the second measurement, the sample is creased and folded, and the Grease Resistance Test is carried out as described above at the location of the fold to determine the Fold Grease Resistance Kit Rating.

A coating is deemed to be flexible if the sample exhibits an Initial Grease Resistance Kit Rating of at least 5, and the sample exhibits a Coating Flexibility such that the Fold Grease Resistance Kit Rating does not drop below 5. In an aspect, the coating composition exhibits a Coating Flexibility such that the Fold Grease Resistance Kit Rating does not drop below 6, or a Coating Flexibility such that the Fold Grease Resistance Kit Rating does not drop below 7, or a Coating Flexibility such that the Fold Grease Resistance Kit Rating does not drop below 8. It will be understood that, for example, in order to achieve a fold Grease Resistance Kit Rating of 8, the Initial Grease Resistance Kit Rating must be at least 8.

In an aspect, the difference between the Initial Grease Resistance Kit Rating and the Fold Grease Resistance Kit Rating is less than 4 Grease Resistance Kit Rating units. In an aspect, the difference between the Initial Grease Resistance Kit Rating and the Fold Grease Resistance Kit Rating is less than 3 Grease Resistance Kit Rating units. In an aspect, the difference between the Initial Grease Resistance Kit Rating and the Fold Grease Resistance Kit Rating is less than 2 Grease Resistance Kit Rating units. In an aspect, the difference between the Initial Grease Resistance Kit Rating and the Fold Grease Resistance Kit Rating is less than 1 Grease Resistance Kit Rating unit.

In an aspect, flexibility of a given coating composition on a rough surface is evaluated by coating the given coating composition on a Standard Rough Surface Substrate, which is defined as a 200 g/m² paper board that is fully coated on the front side, for graphic printing purposes, available as Tambrite™ boxboard from Stora Enso (Stockholm, Sweden). This stock material is treated the backside (i.e., the uncoated side) with the starches to evaluate performance properties of coatings. nOSA starch for barrier purposes. The Standard Rough Surface Substrate has a Bendtsen Roughness value of about 241, and a Bendtsen Porosity value of about 0.3. The Standard Rough Surface Substrate is coated with the coating composition at a coating weight of 6.5 g/m².

In an aspect, a coating composition as described herein is formulated to have an Initial Grease Resistance Kit Rating on a Standard Rough Surface Substrate of at least 5, and the difference between the Initial Grease Resistance Kit Rating and the Fold Grease Resistance Kit Rating is less than 4 Grease Resistance Kit Rating units. In an aspect, a coating composition as described herein is formulated to have an Initial Grease Resistance Kit Rating on a Standard Rough Surface Substrate of at least 5, and the difference between the Initial Grease Resistance Kit Rating and the Fold Grease Resistance Kit Rating is less than 3 Grease Resistance Kit Rating units. In an aspect, a coating composition as described herein is formulated to have an Initial Grease Resistance Kit Rating on a Standard Rough Surface Substrate of at least 5, and the difference between the Initial Grease Resistance Kit Rating and the Fold Grease Resistance Kit Rating is less than 2 Grease Resistance Kit Rating units. In an aspect, a coating composition as described herein is formulated to have an Initial Grease Resistance Kit Rating on a Standard Rough Surface Substrate of at least 5, and the difference between the Initial Grease Resistance Kit Rating and the Fold Grease Resistance Kit Rating is less than 1 Grease Resistance Kit Rating unit.

For purposes of the present disclosure, flexibility of a given coated fiber-based product is measured by conducting the above Coating Flexibility test on the coated fiber-based product to be prepared, whereby a coating composition is applied to a fiber-based substrate to be used in product production (i.e., not the standard paper substrate used above to evaluating performance of the coating alone).

In an aspect, the flexibility of the coated product as determined by the fold and crease challenge (the “Product Coating Flexibility”) is such that the Fold Grease Resistance Kit Rating does not drop below 5. In an aspect, the coated product exhibits a Coating Flexibility such that the Fold Grease Resistance Kit Rating does not drop below 6, or a Coating Flexibility such that the Fold Grease Resistance Kit Rating does not drop below 7, or a Coating Flexibility such that the Fold Grease Resistance Kit Rating does not drop below 8.

In an aspect, the difference between the Initial Grease Resistance Kit Rating and the Fold Grease Resistance Kit Rating is less than 4 Grease Resistance Kit Rating units. In an aspect, the difference between the Initial Grease Resistance Kit Rating and the Fold Grease Resistance Kit Rating is less than 3 Grease Resistance Kit Rating units. In an aspect, the difference between the Initial Grease Resistance Kit Rating and the Fold Grease Resistance Kit Rating is less than 2 Grease Resistance Kit Rating units. In an aspect, the difference between the Initial Grease Resistance Kit Rating and the Fold Grease Resistance Kit Rating is less than 1 Grease Resistance Kit Rating unit.

The coated fiber-based product as described herein can be prepared by providing a fiber-based substrate having a first and second major surface, and coating the first major surface with the aqueous coating composition as described herein. In an aspect, the first major surface is provided with the aqueous coating composition at a coating weight of from 2 g/m² to 15 g/m². In an aspect, the first major surface is provided with the aqueous coating composition at a coating weight of from 2 g/m² to 12 g/m². In an aspect, the first major surface is provided with the aqueous coating composition at a coating weight of from 2 g/m² to 10 g/m². In an aspect, the first major surface is provided with the aqueous coating composition at a coating weight of from 2 g/m² to 4 g/m². In an aspect, the first major surface is provided with the aqueous coating composition at a coating weight of from 5 g/m² to 15 g/m². In an aspect, the first major surface is provided with the aqueous coating composition at a coating weight of from 6 g/m² to 15 g/m². In an aspect, the first major surface is provided with the aqueous coating composition at a coating weight of from 6.5 g/m² to 12 g/m².

In an aspect, the second major surface of the fiber-based substrate is additionally coated with the aqueous coating composition as described herein. In an aspect, the second major surface is provided with the aqueous coating composition at a coating weight of from 2 g/m² to 15 g/m². In an aspect, the second major surface is provided with the aqueous coating composition at a coating weight of from 2 g/m² to 12 g/m². In an aspect, the second major surface is provided with the aqueous coating composition at a coating weight of from 2 g/m² to 10 g/m². In an aspect, the second major surface is provided with the aqueous coating composition at a coating weight of from 2 g/m² to 4 g/m². In an aspect, the second major surface is provided with the aqueous coating composition at a coating weight of from 5 g/m² to 15 g/m². In an aspect, the second major surface is provided with the aqueous coating composition at a coating weight of from 6 g/m² to 15 g/m². In an aspect, the second major surface is provided with the aqueous coating composition at a coating weight of from 6.5 g/m² to 12 g/m².

In an aspect, a coated fiber-based product is provided wherein the substrate prior to coating has a Bendtsen Roughness value of from about 100 to about 800 ml/min, and wherein the substrate is coated with a composition as described herein at a coating weight of from about 4 to about 15 g/m². In an aspect, a coated fiber-based product is provided wherein the substrate prior to coating has a Bendtsen Roughness value of from about 100 to about 800 ml/min, and wherein the substrate is coated with a composition as described herein at a coating weight of from about 5 g/m² to 15 g/m². In an aspect, a coated fiber-based product is provided wherein the substrate prior to coating has a Bendtsen Roughness value of from about 100 to about 800 ml/min, and wherein the substrate is coated with a composition as described herein at a coating weight of from about 6 g/m² to 15 g/m². In an aspect, a coated fiber-based product is provided wherein the substrate prior to coating has a Bendtsen Roughness value of from about 100 to about 800 ml/min, and wherein the substrate is coated with a composition as described herein at a coating weight of from about 6.5 g/m² to 12 g/m²

In an aspect, a coated fiber-based product is provided wherein the substrate prior to coating has a Bendtsen Roughness value of from about 0.3 to about 10 ml/min, and wherein the substrate is coated with a composition as described herein at a coating weight of from about 2 to about 4 g/m².

The coating composition as described herein can be applied to a paper substrate by any suitable known coating technique, such as, for example, air knife coating, rod coating, bar coating, wire bar coating, spray coating, brush coating, cast coating, flexible blade coating, gravure coating, jet applicator coating, extrusion coating, short dwell coating, slide hopper coating, curtain coating, flexographic coating, size-press coating, gate roll coating, reverse roll coating and transfer roll coating. In an aspect, the coating composition is applied as a single coat to a major surface of the paper substrate. In an aspect, the coating composition is applied a plurality of times to a major surface of the paper substrate. In an aspect, the coating composition is applied as a single coat to both sides (i.e., both major surfaces) of the paper substrate. In an aspect, the coating composition is applied a plurality of times to both sides (i.e., both major surfaces) of the paper substrate.

### EXAMPLES

### A. Preparation of Aqueous Coating Compositions

Coating compositions were prepared as follows:

### Example 1 (Comparative)

A commercially available thinned hydroxypropylated corn starch (C*Film 05773) that was not modified with n-OSA was prepared for coating by cooking in water with moderate stirring at a temperature of about 95 degrees C. for a time of about 0.5 hours to gelatinize the starch. The water content of the gelatinized starch was adjusted as necessary to provide an aqueous coating composition having a solids content of 20%. The resulting aqueous coating composition had a viscosity level of around 1100 mPas at 30° C. Brookfield 100 rpm.

### Example 2 (Comparative)

A native waxy corn starch that was not modified with n-OSA was prepared for coating by cooking in water with moderate stirring at a temperature of about 95 degrees C. for a time of about 0.5 hours to gelatinize the starch. The water content of the gelatinized starch was adjusted as necessary to provide an aqueous coating composition having a solids content of 20%. The starch was then enzymatically thinned using an alpha-amylase enzyme (e.g., Warozyme A152), to provide an aqueous coating composition having a viscosity of around 1280 mPas at 30° C. Brookfield 100 rpm.

### Example 3

An acid thinned nOSA modified waxy corn starch with a MW of around 1,100,000-1,200,000 and a degree of substitution of around 0.005 (“n-OSA Starch 1”) was prepared for coating by cooking in water with moderate stirring at a temperature of about 95 degrees C. for a time of about 0.5 hours to gelatinize the starch. The water content of the gelatinized starch was adjusted as necessary to provide an aqueous coating composition having a solids content of 20%. The resulting aqueous coating composition had a viscosity level of around 1280 mPas at 30° C. Brookfield 100 rpm.

### B. Preparation of Coated Substrates

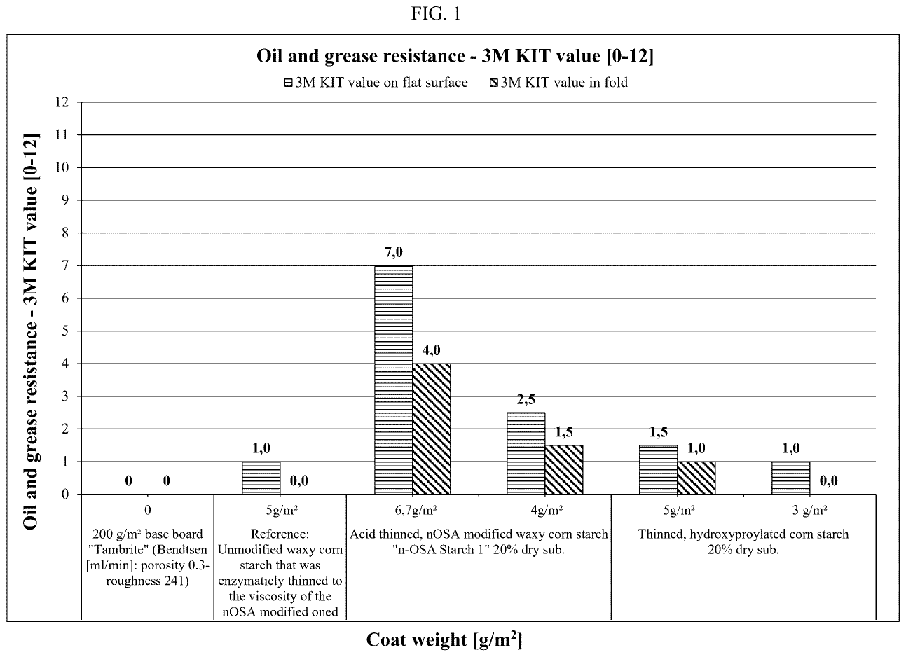

The aqueous coating compositions as described above were coated on the uncoated side of Tambrite™ boxboard in single coating steps with a rod lab coater (TQC) at the same dry substance content level of 20% without further additives. The coating weights of the samples are indicated in FIG. 1. The samples were dried at room temperature.

### C. Evaluation of Properties of Coated Sheets

After conditioning of the samples at 23° C. and 50% RH for at least 24 h, the coated samples and a control sample of Tambrite™ boxboard without additional coating applied thereto were evaluated according to the 3M KIT method, on the flat surface and afterwards in a fold that was generated according to following method: First a creasing step (with an office device), then folding (90%) and folding back. The experimental results are presented in graph form in FIG. 1. As can be seen in in FIG. 1, the n-OSA starch as described herein provides excellent oil and grease resistance and flexibility characteristics as compared to both the unmodified waxy corn starch and the hydroxypropylated corn starch.

In particular, the n-OSA starch as described herein surprisingly exhibits superior oil and grease resistance and flexibility characteristics even when coated at a lower coating weight than either of the unmodified waxy corn starch and the hydroxypropylated corn starch. Moreover, the n-OSA starch as described herein surprisingly provides exceptionally higher oil and grease resistance and superior flexibility characteristics when coated at the somewhat higher coating weight of 6.7 g/m² coating weight.

As used herein, the terms “about” or “approximately” mean within an acceptable range for the particular parameter specified as determined by one of ordinary skill in the art, which will depend in part on how the value is measured or determined, e.g., the limitations of the sample preparation and measurement system. Examples of such limitations include preparing the sample in a wet versus a dry environment, different instruments, variations in sample height, and differing requirements in signal-to-noise ratios. For example, “about” can mean greater or lesser than the value or range of values stated by 1/10 of the stated values, but is not intended to limit any value or range of values to only this broader definition. For instance, a concentration value of about 30% means a concentration between 27% and 33%. Each value or range of values preceded by the term “about” is also intended to encompass the embodiment of the stated absolute value or range of values. Alternatively, particularly with respect to biological systems or processes, the term can mean within an order of magnitude, preferably within 5-fold, and more preferably within 2-fold, of a value.

Throughout this specification and claims, unless the context requires otherwise, the word “comprise”, and variations such as “comprises” and “comprising”, will be understood to imply the inclusion of a stated integer or step or group of integers or steps but not the exclusion of any other integer or step or group of integer or step. When used herein “consisting of” excludes any element, step, or ingredient not specified in the claim element. When used herein, “consisting essentially of” does not exclude materials or steps that do not materially affect the basic and novel characteristics of the claim. In the present disclosure of various embodiments, any of the terms “comprising”, “consisting essentially of” and “consisting of” used in the description of an embodiment may be replaced with either of the other two terms.

All patents, patent applications (including provisional applications), and publications cited herein are incorporated by reference as if individually incorporated for all purposes. Unless otherwise indicated, all parts and percentages are by weight and all molecular weights are weight average molecular weights. The foregoing detailed description has been given for clarity of understanding only. No unnecessary limitations are to be understood therefrom. The invention is not limited to the exact details shown and described, for variations obvious to one skilled in the art will be included within the invention defined by the claims.

1. An aqueous coating composition for providing a barrier coating on fiber-based substrates comprising:
an n-OSA modified starch having an Mw of from about 500,000 to about 1,300,000 and a degree of substitution of from 0.002 to about 0.009, the n-OSA modified starch being present as from about 5 wt % to about 40 wt % of the total aqueous coating composition;
wherein the aqueous coating composition:
has a Brookfield viscosity at 30° C. at 100 rpm of from about 50 to about 2500 mPas; and
the n-OSA modified starch is at least about 92% of any starch present in the aqueous coating composition.

2. The aqueous coating composition of claim 1, wherein
a). the n-OSA modified starch has an Mn of from about 25,000 to about 35,000; and/or
b). the n-OSA modified starch has a polydispersity of from about 35 to about 50.

3-11. (canceled)

12. The aqueous coating composition of claim 1, wherein the n-OSA modified starch is a starch prepared from a starch selected from the group consisting of maize starch, potato starch, sweet potato starch, wheat starch, rice starch, tapioca starch, sorghum starch, waxy maize starch, waxy potato starch, waxy sweet potato starch, waxy wheat starch, waxy rice starch, waxy tapioca starch, and waxy sorghum starch.

13. The aqueous coating composition of claim 1, wherein the n-OSA modified starch is a starch prepared from a starch having an amylopectin content of from about 85 to 100% by weight.

14. The aqueous coating composition of claim 1, wherein the n-OSA starch is a starch prepared from only one type of starch source.

15. The aqueous coating composition of claim 1, wherein the n-OSA starch present in the aqueous coating composition comprises mixtures of n-OSA starches that have been prepared from two or more types of starch sources.

16. The aqueous coating composition of claim 1, wherein the aqueous coating composition is substantially free of intentionally added Microplastics.

17. The aqueous coating composition of claim 1, wherein the aqueous coating composition is substantially free of intentionally added fluorine containing components.

18. The aqueous coating composition of claim 1, wherein the aqueous coating composition comprises talc in an amount of from about 20 wt % to about 40 wt % of the coating composition.

19. The aqueous coating composition of claim 18, wherein the talc has an average particle size of from about 1 to 25 μm.

20. The aqueous coating composition of claim 1, wherein the aqueous coating composition comprises pigment in an amount of from about 1 wt % to about 20 wt % of the coating composition.

21. The aqueous coating composition of claim 1, wherein the aqueous coating composition has a total dry solids content of from about 15 to about 50 wt %.

22. The aqueous coating composition of claim 1, wherein the composition when coated on a Standard Rough Surface Substrate in a coating weight of 6.5 g/m² has a Coating Flexibility such that Initial Grease Resistance Kit Rating on a Standard Rough Surface Substrate of at least 5, and the difference between the Initial Grease Resistance Kit Rating and the Fold Grease Resistance Kit Rating is less than 4 Grease Resistance Kit Rating units.

23. A coated fiber-based product comprising a coating applied from the aqueous coating composition of claim 1.

24. The coated fiber-based product of claim 23, wherein the fiber-based substrate is a paper sheet substrate having a Bendtsen Porosity value of from about 0.3 to 700 ml/min prior to coating with the composition.

25. The coated fiber-based product of claim 23, wherein the coated fiber-based product exhibits:
a Grease Resistance Kit Rating of from 5 to 12; and/or
a Coating Flexibility such that the Fold Grease Resistance Kit Rating does not drop below 5.

26. A method of making a coated fiber-based product, comprising:
providing a fiber-based substrate having a first and second major surface and coating the first major surface with the aqueous coating composition of claim 1 at a coating weight of from 2 g/m² to 15 g/m².

27. A method of making a coated fiber-based product comprising coating a fiber-based substrate with the aqueous coating composition of claim 1 in an amount effective to provide a coated fiber-based product that exhibits:
a Grease Resistance Kit Rating of from 5 to 12, and
a Coating Flexibility such that the Grease Resistance Kit Rating does not drop below 5 after creasing and folding of the coated fiber-based product.

28. A coated fiber-based product made by the method of claim 26.

29. Use of an aqueous coating composition of claim 1 in making a coated fiber-based product.
